(19) United States
(12) Patent Application Publication
(10) Pub. No.: US 2021/0187656 A1
(43) Pub. Date: Jun. 24, 2021

(54) METHOD FOR MANUFACTURING A HYDRAULIC HOUSING, HYDRAULIC HOUSING

(71) Applicant: Robert Bosch GmbH, Stuttgart (DE)

(72) Inventors: Anna Regensburg, Rueckholz (DE); Fabian Haenle, Missen-Wilhams (DE); Martin Hagspiel, Rettenberg (DE); Maximilian Wilhelm, Buchenberg (DE)

(21) Appl. No.: 17/090,047

(22) Filed: Nov. 5, 2020

(30) Foreign Application Priority Data
Dec. 20, 2019 (DE) 102019220326.4

(51) Int. Cl. B23K 20/12

(52) U.S. Cl. CPC B23K 20/129; B23K 2103/10; B23K 20/1265

(57) ABSTRACT

A method for manufacturing a hydraulic housing for a braking system of a motor vehicle. A cylindrical or hollow-cylindrical first housing part and a second housing part of the hydraulic housing are integrally joined using friction welding. The method includes: a) attaching the first housing part to the second housing part, an end face of the first housing part being attached to the second housing part so that a shared contact area is created, b) plasticizing the two housing parts in the contact area and/or in a joint area adjoining the contact area by friction-based heat introduction, and c) compressing at least one housing part and/or pressing a friction welding tool against the housing parts so that material forming and/or material shearing is effectuated in the plasticized area of the two housing parts and both housing parts form an integral joint in the contact area and/or in the joint area.

### CROSS REFERENCE

The present application claims the benefit under 35 U.S.C. § 119 of German Patent Application No. DE 102019220326.4 filed on Dec. 20, 2019, which is expressly incorporated herein by reference in its entirety.

### FIELD

The present invention relates to a method for manufacturing a hydraulic housing. When the method is carried out, a cylindrical or hollow-cylindrical first housing part of the hydraulic housing is integrally joined with a second housing part.

In addition, the present invention relates to a hydraulic housing for a braking system of a motor vehicle.

### BACKGROUND INFORMATION

Braking systems of motor vehicles having internal combustion engines use the vacuum of the internal combustion engine for vacuum-based brake boosting. For electrified driving or for new, more efficient engine generations, however, another vacuum-dependent brake boosting is required. Electromechanical pressure buildup in a cylinder-piston system represents one option. Due to the required dimensions, the cylinder of such a system has heretofore either been implemented via completely separate components or the hydraulic housing has been made thicker as a whole and machined appropriately. Since the machining processing is accompanied by high material costs, the multipart construction using semifinished products which are subsequently joined has been given priority. The joint areas are subjected to high dynamic stresses in the product life cycle, however, so that high demands are placed on the joining technology. Moreover, the joining method has to ensure that the hydraulic housing is gas-tight and water-tight in the joint area.

If semifinished products made of a high-strength aluminum alloy and a conventional fusion welding method are used, in particular hot cracking and pore formation and also softening of the resulting fused microstructure may occur. The required bonding properties are no longer ensured.

At this point, solid phase joining processes, in particular friction-based methods, offer an option for manufacturing integral joints without the formation of a shared weld pool. For example, a method for manufacturing a transmission housing for a motor vehicle is described in German Patent Application NO. DE 10 2015 002 434 A1, in which a housing part and a reinforcing part are connected to one another in an integrally-joined manner with the aid of friction stir welding. A transmission housing is to be provided in this way which has a high strength with low weight at the same time.

An object of the present invention is to provide a simplified method for manufacturing a hydraulic housing which is dynamically highly resilient and is moreover gas-tight and water-tight.

The object may be achieved by example embodiments of the present invention. Advantageous embodiments and refinements of the present invention are disclosed herein.

### SUMMARY

In accordance with an example embodiment of the present invention, in a method for manufacturing a hydraulic housing for a braking system of a motor vehicle, a cylindrical or hollow-cylindrical first housing part and a second housing part of the hydraulic housing are integrally joined with the aid of friction welding. The example method includes the following steps:
a) attaching the cylindrical or hollow-cylindrical first housing part to the second housing part, an end face of the first housing part being attached to the second housing part so that a shared contact area is created,
b) plasticizing the two housing parts in the contact area and/or in a joint area adjoining the contact area by friction-based heat introduction, and
c) compressing at least one housing part and/or pressing a friction welding tool against the housing parts so that material forming and/or material shearing is effectuated in the plasticized area of the two housing parts and both housing parts form an integral joint in the contact area and/or in the joint area.

In contrast to a conventional fusion welding method, in the example method of the present invention, the base materials of the two housing parts to be joined are not melted, rather only plasticized by friction-based heat introduction. Accordingly, the softening of the base materials in the heat influence zone of the two housing parts is minimal. In this way, an integral joint is created which withstands high dynamic stresses and moreover is free of hot cracking and pores, so that it is furthermore ensured that the connection is gas-tight and water-tight. An integral joint having fine-grained microstructure and excellent mechanical properties is manufactured by dynamic recrystallization. Moreover, any oxide and/or foreign material layers present in the contact and/or joint area are broken up by the compression and/or pressing on of a friction tool, which reduces the sensitivity of the provided method to environmental and/or batch influences.

With the aid of the example method of the present invention, housing parts made of the same or similar or of different materials may be integrally joined. For example, aluminum-aluminum compounds or composite constructions, for example, aluminum-steel or aluminum-copper compounds may be implemented. Furthermore, it is possible to integrally join two housing parts made of an aluminum alloy which are not suitable or only have limited suitability for fusion welding. In comparison to conventional fusion welding methods, the requirements for the preparation and/or the cleaning of the surfaces in the joint area are moreover minimal.

The joint area is identical to and/or adjoins the contact area. The contact area is annular, since the cylindrical or hollow-cylindrical first housing part is attached via its end face to the second housing part. The second housing part may have an arbitrary shape. For example, it may also be cylindrical or hollow-cylindrical or cuboid. The second housing part preferably forms a flat contact surface, to which the end face of the first housing part may be attached.

According to a first preferred specific embodiment of the present invention, the heat introduction required in step b) is generated by friction between the two housing parts. The friction between the two housing parts in the contact area generates the heat required for the plasticization. For this purpose, at least one housing part is moved, preferably rotated, in relation to the other housing part. This method is also called rotation friction welding. A separate friction welding tool is not required in this case.

According to an alternative preferred specific embodiment of the present invention, the heat introduction required in step b) is generated by friction between the friction welding tool and the two housing parts. In this case, only the friction welding tool is moved in relation to the two housing parts to be joined. The method is also called friction stir welding.

With the aid of both methods, i.e., both with the aid of friction stir welding and also with the aid of rotation friction welding, an integral joint may be manufactured without forming a shared weld pool. Friction stir welding merely uses an additional tool in contrast to rotation friction welding.

If a friction welding tool is used, it is preferably attached in the joint area to the two housing parts at a work angle, pressed on, and rotated around its own longitudinal axis. The friction welding tool is guided along the joint area at the same time. Since the cylindrical or hollow-cylindrical first housing part presses against the second housing part via its end face, the friction welding tool has to be guided in the joint area along the outer circumference of the first housing part. A flat contact surface of the second housing part proves to be advantageous in this case.

A friction welding tool having a stationary, asymmetrical shoulder is preferably used for the friction welding, in particular friction stir welding. With the aid of such a tool, in particular fillet welds near net shape may be manufactured easily.

If the use of a friction welding tool is omitted, the cylindrical or hollow-cylindrical first housing part is preferably pressed against the second housing part and rotated around its own longitudinal axis. Friction arises due to the rotating movement of the first housing part in relation to the second housing part, which results in the heat introduction required for the plasticization in step b). A flat contact surface is not only advantageous, but absolutely necessary in this case. A welding bead made of compressed plasticized material is preferably formed by the compression in step c). This still further increases the required leak-tightness of the integral joint.

A circumferential fillet weld or a circumferential welding bead is thus preferably implemented in step c) of the method according to the present invention.

In addition, in accordance with an example embodiment of the present invention, a hydraulic housing for a braking system of a motor vehicle is provided to achieve the object mentioned at the outset. The hydraulic housing includes a cylindrical or hollow-cylindrical first housing part and a second housing part, the first housing part resting against the second housing part via an end face, so that both housing parts have a shared contact area. Both housing parts are integrally joined with the aid of friction welding in the contact area and/or in a joint area adjoining the contact area.

The example hydraulic housing has a high dynamic load capacity due to the integral joint of the two housing parts manufactured with the aid of friction welding. Moreover, it is gas-tight and water-tight, since the joint has a fine-grained microstructure in the joint area, which is moreover largely free of pores. The provided hydraulic housing has preferably been manufactured according to the above-described method according to the present invention, so that it is particularly simple and cost-effective to manufacture at the same time. This applies in particular in relation to a hydraulic housing which has been manufactured in a machining method.

The integral joint is preferably formed via a circumferential fillet weld or a circumferential welding bead. The fillet weld is at least near net shape.

Furthermore, at least one housing part is preferably manufactured from a metallic material, for example, from aluminum or an aluminum alloy. Since such materials generally have only limited suitability for fusion welding, the advantages of the present invention come to bear particularly clearly here.

Preferred specific embodiments of the present invention are explained in greater detail hereinafter on the basis of the figures.

### BRIEF DESCRIPTION OF THE DRAWINGS

FIG. 1 shows a schematic longitudinal section through a first hydraulic housing according to an example embodiment of the present invention during the joining of two housing parts.

FIG. 2 shows a schematic side view of a further hydraulic housing according to an example embodiment of the present invention during the joining of two housing parts.

### DETAILED DESCRIPTION OF EXAMPLE EMBODIMENTS

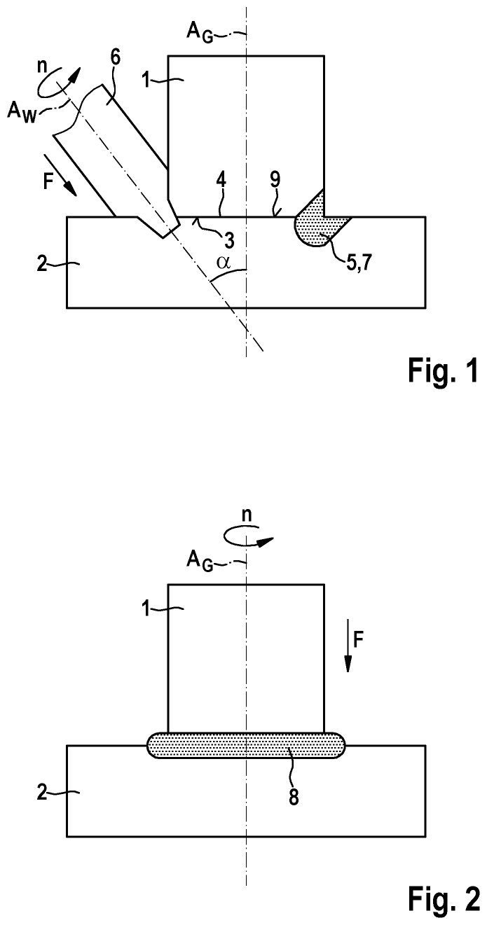

A cylindrical first housing part 1 and a cuboid second housing part 2 of a hydraulic housing are shown in FIGS. 1. To manufacture the hydraulic housing, the two housing parts 1, 2 have to be joined in a gas-tight and water-tight manner. Since the hydraulic housing is moreover subjected to high dynamic stresses in its product life cycle, softening in the joint area due to melting of the material is to be avoided. The two housing parts 1, 2 are therefore integrally joined with the aid of friction stir welding.

Before the integral joining, first housing part 1 is attached via an end face 3 to second housing part 2, so that the two housing parts 1, 2 are linked together in a shared contact area 4. Contact area 4 is formed on second housing part 2 by flat contact surface 9. With the aid of a friction welding tool 6, which is pressed at a work angle α in a joint area 5 against the two housing parts 1, 2 (pressure F) and rotated around its longitudinal axis A_{W}, plasticization of the material is effectuated in joint area 5, so that friction welding tool 6 is dipped into the plasticized material. At the same time, friction welding tool 6 is moved around the outer circumference of first housing part 1 while maintaining work angle α and pressure F. The result is a near-net-shape fillet weld 7.

As shown by way of example in FIG. 2, an integral joint may be manufactured between the two housing parts 1, 2 even without friction welding tool 6. For this purpose, cylindrical first housing part 1 is simply attached via its end face 3 to a flat contact surface 9 of second housing part 2 and pressed on (pressure F) and also rotated around its longitudinal axis A_{G}. A plasticization of the material in contact area 4 is achieved by the rotation of first housing part 1 in relation to second housing part 2. Pressure F with which first housing part 1 is pressed or compressed against second housing part 2 has the result that plasticized material is raised to form a welding bead 8. Welding bead 8 strengthens the welded joint.

Cylindrical first housing part 1 shown in FIGS. 1 and 2 may alternatively be hollow-cylindrical in each case.

What is claimed is:

1. A method for manufacturing a hydraulic housing for a braking system of a motor vehicle, in which a cylindrical or hollow-cylindrical first housing part and a second housing part of the hydraulic housing are integrally joined using friction welding, the method comprising the following steps:
a) attaching the cylindrical or hollow-cylindrical first housing part to the second housing part, an end face of the first housing part being attached to the second housing part so that a shared contact area is created;
b) plasticizing, by friction-based heat introduction, the two first and second housing parts in the contact area and/or in a joint area adjoining the contact area; and
c) compressing at least one of the first and second housing parts and/or pressing a friction welding tool against the first and second housing parts so that material forming and/or material shearing is effectuated in the plasticized contact area and/or joint area, and both of the first and second housing parts form an integral joint in the contact area and/or in the joint area.

2. The method as recited in claim 1, wherein the heat introduction in step b) is generated by friction between the first and second housing parts and/or by friction between the friction welding tool and the first and second housing parts.

3. The method as recited in claim 1, wherein the friction welding tool is attached to the first and second housing parts in the joint area at a work angle, pressed on, and rotated around its longitudinal axis, the friction welding tool being guided along the joint area at the same time.

4. The method as recited in claim 1, wherein the friction welding tool includes a stationary, asymmetrical shoulder and is used for the friction welding, the friction welding being a friction stir welding.

5. The method as recited in claim 1, wherein the cylindrical or hollow-cylindrical first housing part is pressed against the second housing part and rotated around its longitudinal axis.

6. The method as recited in claim 1, wherein a circumferential fillet weld or a circumferential welding bead is implemented in step c).

7. A hydraulic housing for a braking system of a motor vehicle, comprising:
a cylindrical or hollow-cylindrical first housing part; and
a second housing part, the first housing part resting against the second housing part via an end face, so that both of the first and second housing parts have a shared contact area, both of the first and second housing parts being integrally joined using friction welding in the contact area and/or in a joint area adjoining the contact area.

8. The hydraulic housing as recited in claim 7, wherein the integral joint is formed via a circumferential fillet weld and/or a circumferential welding bead.

9. The hydraulic housing as recited in claim 7, wherein at least one of the first and second housing parts is made from a metallic material.

10. The hydraulic housing as recited in claim 9, wherein the metallic material is aluminum or an aluminum alloy.
